(19) United States
(12) Patent Application Publication
(10) Pub. No.: US 2014/0344565 A1
(43) Pub. Date: Nov. 20, 2014

(54) DATA CENTER SYSTEM AND METHOD FOR DYNAMICALLY UPDATING CONFIGURATION INFORMATION THEREOF

(71) Applicant: HON HAI PRECISION INDUSTRY CO., LTD., New Taipei (TW)

(72) Inventor: CHIH-HUANG WU, New Taipei (TW)

(73) Assignee: HON HAI PRECISION INDUSTRY CO., LTD., New Taipei (TW)

(21) Appl. No.: 14/279,322

(22) Filed: May 16, 2014

(30) Foreign Application Priority Data
May 16, 2013 (TW) 102117332

(51) Int. Cl. G06F 9/445

(52) U.S. Cl. CPC G06F 8/65; G06F 9/44505
USPC 713/100

(57) ABSTRACT

A data center system and a method for dynamically updating configuration information of the data center system are provided. The data center system includes a storage compartment, a storage device, and a control device. The storage compartment houses a plurality of single data center units SDCUs. The storage device stores configuration information of the data center system and configuration parameters of each of the SDCUs housed in the storage compartment. When a new SDCU is added to the data center system, the control device receives the configuration parameters of the new SDCU, and stores the configuration parameters of the new SDCU. The control device further updates the stored configuration information of the data center system using the configuration parameters of all of the SDCUs employed in the data center system, and runs the data center system based on the updated configuration information.

### FIELD

The subject matter herein generally relates to a data center system employing multiple single data center units, and a method for dynamically updating configuration information of the data center system.

### BACKGROUND

A number of single data center units (SDCUs) are provided for a large data center system. The configuration information of each SDCU is also provided for the data center system, to ensure normal starting and running of the data center system. As the data center system runs, if the configuration information of an existing SDCU is changed, or a new SDCU is added to the data center system, the running data center system must be restarted to obtain the changed configuration information or configuration information for the new SDCU.

### BRIEF DESCRIPTION OF THE DRAWINGS

Implementations of the present technology will be described, by way of example only, with reference to the attached figures, wherein:

FIG. 1 shows one embodiment of a data center system employing multiple SDCUs.

FIG. 2 shows a control circuit module of each of the SDCUs of FIG. 1.

FIG. 3 shows configuration parameters set by a setting device of each of the SDCUs of FIG. 1.

FIG. 4 is a flowchart illustrating a method for dynamically updating configuration information of the data center system of FIG. 1.

### DETAILED DESCRIPTION

For simplicity and clarity, reference numerals have been repeated in the different figures to indicate corresponding or analogous elements. Specific details are set forth to provide a thorough understanding of the embodiments described herein but those of ordinary skill in the art know that the embodiments described herein can be made without these specific details. The descriptions are not to be considered as limiting the scope of the embodiments described herein. The drawings are not necessarily to scale and the proportions of certain parts have been exaggerated to better illustrate details and features of the present disclosure.

Several definitions applied in this disclosure are:

The term “coupled” is defined as connected through intervening components or not, and such connections may be physical or electrical. The connection can be such that the objects are permanently connected or releasably connected. The term “comprising” means “including, but not necessarily limited to” and specifically indicates open-ended inclusions or memberships in combinations, groups, series, and the like.

The present disclosure is about a data center system and a method for dynamically updating configuration information of the data center system. The data center system includes a storage compartment, a storage device, and a control device. The storage compartment is configured to house a plurality of single data center units (SDCUs). The storage device is configured to store configuration information of the data center system and configuration parameters of each of the SDCUs housed in the storage compartment. The control device is coupled to each of the housed SDCUs. When a new SDCU is added to the data center system, the control device receives the configuration parameters from the new SDCU, and stores the configuration parameters of the new SDCU in the storage device. The control device further updates the stored configuration information of the data center system using the configuration parameters of all of the SDCUs employed in the data center system, and runs the data center system based on the updated configuration information.

The present disclosure is also about an SDCU. The SDCU includes a storage compartment and a control circuit module. The storage compartment is configured to house a master device or a slave device. The control circuit module includes a setting device, an interface, and a microcontroller coupled between the setting device and the interface. The setting device is configured to set configuration parameters of the SDCU according to the configuration of the storage compartment. When the SDCU is added to a data center system, the microcontroller of the SDCU transmits the configuration parameters of the SDCU to a control device of the data center system via the interface.

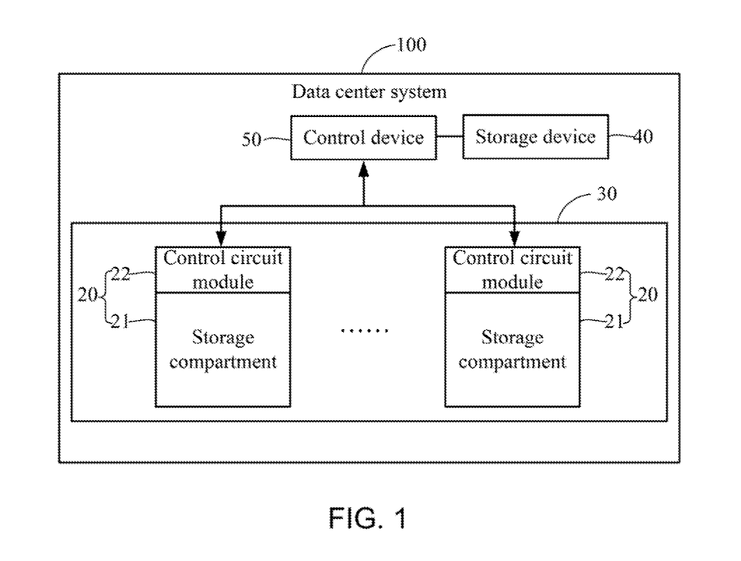

FIG. 1 shows one embodiment of a data center system 100. The data center system 100 includes a storage compartment 30, a storage device 40, and a control device 50. The storage compartment 30 can house a number of SDCUs 20. The storage device 40 can store configuration information of the data center system 100 and configuration parameters of each of the SDCUs 20 housed in the storage compartment 30. The control device 50 is coupled to each of the housed SDCUs 20.

In the embodiment, each of the SDCUs 20 includes a storage compartment 21 and a control circuit module 22. The storage compartment 21 can house a master device or a slave device.

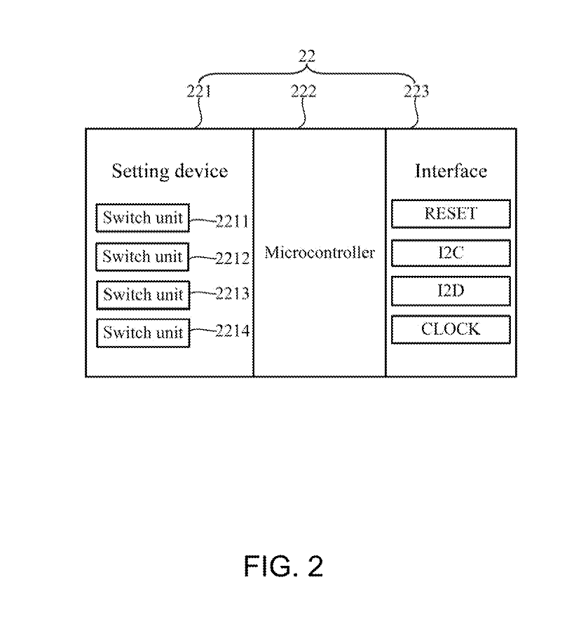

FIG. 2 shows that the control circuit module 22 of each of the SDCUs 20 includes a setting device 221, an interface 223, and a microcontroller 223 coupled between the setting device 221 and the interface 223. The setting device 221 can set configuration parameters of the SDCU 20 according to the configuration of the storage compartment 21.

In the embodiment, the setting device 221 includes a number of two-state switch units, such as switches 2211˜2214, each of these switch units can be switched between state “0” and state “1”. Each of the switch units is configured to set part of the designation of the configuration parameters, the configuration parameters comprising the height, the width, the type, and the master or slave role of the device housed in the storage compartment 21. When the SDCUs 20 are added to the data center system 100, the microcontroller 222 of each of the SDCUs 20 transmits the configuration parameters of the SDCUs 20 to the control device 50 of the data center system 100 via the interface 223.

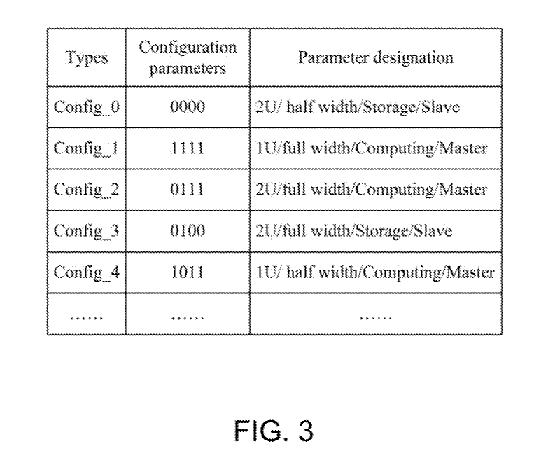

In the embodiment, the different sizes of the devices housed in the storage compartment 21 are preset, the heights being 1U or 2U, and the widths being full width or half width, wherein 1U=4.445 cm and full width=48.26 cm=19 inch. Therefore, as illustrated in FIG. 3, the configuration parameters of each of the SDCUs 20 set by the setting device 221 is a multi-bit binary code. In the embodiment, the setting device 221 is a DIP switch.

When the SDCU 20 is added to a data center system 100, the microcontroller 222 of the SDCU 20 can transmit the configuration parameters of the SDCU 20 to the control device 50 via the interface 223.

The control device 50 can receive the configuration parameters from the new

SDCU 20 and store the configuration parameters of the new SDCU 20 in the storage device 40, update the stored configuration information of the data center system 100 using the configuration parameters of all of the SDCUs 20 employed in the data center system 100, and run the data center system 100 based on the updated configuration information.

When one of the SDCUs 20 is taken away from the data center system 100, the control device 50 can delete the configuration parameters of the removed SDCU 20 from the storage device 40, and update the stored configured information of the data center system 100 using the configuration parameters of the remaining SDCUs 20 still employed in the data center system 100.

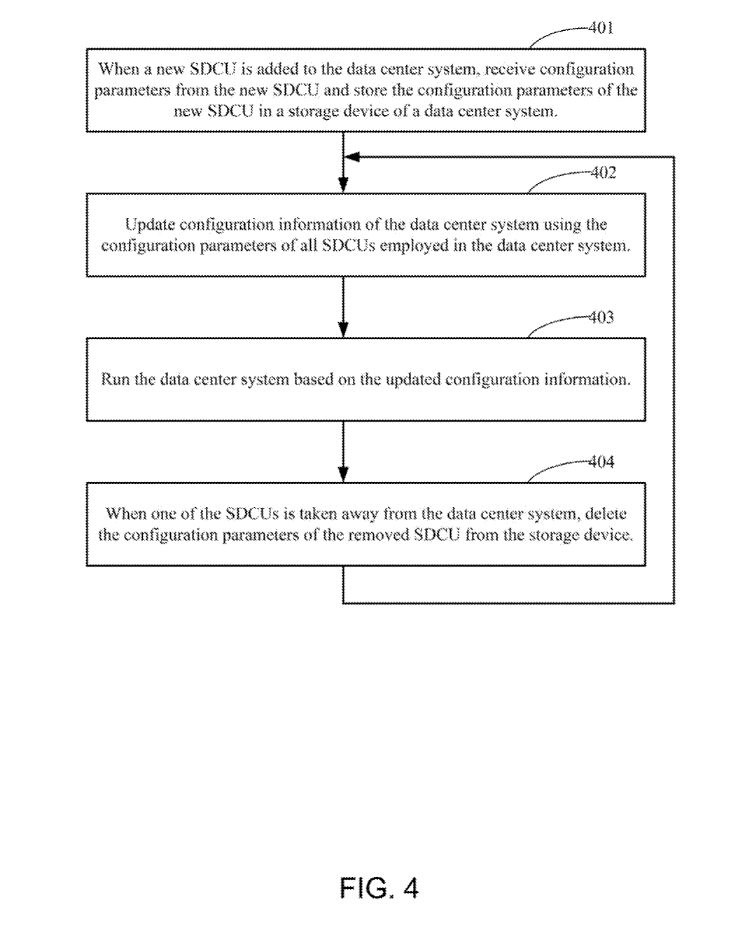

FIG. 4 is a flowchart illustrating a method for dynamically updating configuration information of a data center system. The data center system includes a storage compartment, a storage device, and a control device. The storage compartment can house a number of SDCUs, and the storage device can store configuration information of the data center system and configuration parameters of each of the SDCUs housed in the storage compartment.

In block 401, when a new SDCU is added to the data center system, a control device of the data center system receives configuration parameters from the new SDCU, and stores the configuration parameters of the new SDCU in the storage device.

In block 402, the control device updates the stored configuration information of the data center system using the configuration parameters of all of the SDCUs employed in the data center system.

In block 403, the control device runs the data center system based on the updated configuration information.

In block 404, when one of the SDCUs is taken away from the data center system, the control device deletes the configuration parameters of the removed SDCU from the storage device, and the procedure returns to block 402.

The embodiments shown and described above are only examples. Many details such as other features of a data center system and an SDCU are not shown or described. Even though numerous characteristics and advantages of the present technology have been set forth in the foregoing description, together with details of the structure and function of the present disclosure, the disclosure is illustrative only, and changes may be made in detail, especially in the matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for dynamically updating configuration information of a data center system, the data center system comprising a storage compartment, and a storage device, wherein the storage compartment is configured to house a plurality of single data center units (SDCUs), and the storage device is configured to store configuration information of the data center system and configuration parameters of each of the SDCUs housed in the storage compartment, the method comprising:
when a new SDCU is added to the data center system, receiving the configuration parameters from the new SDCU, and storing the configuration parameters of the new SDCU in the storage device;
updating the stored configuration information of the data center system using the configuration parameters of all of the SDCUs employed in the data center system; and
running the data center system based on the updated configuration information.

2. The method as described in claim 1, further comprising:
when one of the SDCUs is taken away from the data center system, deleting the configuration parameters of the removed SDCU from the storage device, and updating the stored configured information of the data center system using the configuration parameters of the remaining SDCUs still employed in the data center system.

3. A single data center unit (SDCU, 20) comprising:
a storage compartment (21) configured to house a master device or a slave device; and
a control circuit module (22) comprising:
a setting device (221) configured to set configuration parameters of the SDCU (20) according to the configuration of the storage compartment (21); and
an interface (223) and a microcontroller (222) coupled between the setting device (221) and the interface (223);
wherein when the SDCU (20) is added to a data center system (100), the microcontroller (222) of the SDCU (20) is configured to transmit the configuration parameters of the SDCU (20) to a control device (50) of the data center system (100) via the interface (223).

4. The SDCU (20) as described in claim 3, wherein the setting device (221) comprises a plurality of two-state switch units (2211˜2214), each of the switch units (2211˜2214) is configured to set part of the designation of the configuration parameters, the configuration parameters comprising the height, the width, the type, and the master or slave role of the device housed in the storage compartment (21), and wherein the configuration parameters of the SDCU (20) is a multi-bit binary code.

5. The SDCU (20) as described in claim 4, wherein the setting device (221) is a DIP switch.

6. A data center system (100), comprising:
a storage compartment (30) configured to house a plurality of single data center units (SDCUs, 20);
a storage device (40) configured to store configuration information of the data center system (100) and configuration parameters of each of the SDCUs (20) housed in the storage compartment (30); and
a control device (50) coupled to each of the housed SDCUs (20);
wherein when a new SDCU (20) is added to the data center system (100), the control device (50) is configured to receive the configuration parameters from the new SDCU (20) and store the configuration parameters of the new SDCU (20) in the storage device (40), update the stored configuration information of the data center system (100) using the configuration parameters of all of the SDCUs (20) employed in the data center system (100), and run the data center system (100) based on the updated configuration information.

7. The data center system (100) as described in claim 6, wherein when one of the SDCUs (20) is taken away from the data center system (100), the control device (50) is configured to delete the configuration parameters of the removed SDCU (20) from the storage device (40), and update the stored configured information of the data center system (100) using the configuration parameters of the remaining SDCUs (20) still employed in the data center system (100).
